(19) United States
(12) Patent Application Publication
(10) Pub. No.: US 2026/0298281 A1
(43) Pub. Date: Oct. 1, 2026

(54) HIGH STRENGTH THREAD LOCKING SYSTEM

(71) Applicant: Kyung Tae Kim, Laguna Niguel, CA (US)

(72) Inventor: Kyung Tae Kim, Laguna Niguel, CA (US)

(21) Appl. No.: 19/567,183

(22) Filed: Mar. 15, 2026

Related U.S. Application Data
(60) Provisional application No. 63/777,539, filed on Mar. 25, 2025.

(51) Int. Cl. F16B 39/22

(52) U.S. Cl. CPC F16B 39/225

(57) ABSTRACT

A threaded screw/bolt locking system which utilizes disruptions in the system's threads which in turn affects “Locking Compound Keys” to increase the system's locking force when the Locking Compound hardens. In some embodiments, a system that utilizes both right and left threads.

This application claims priority to U.S. provisional applications 63/777,539 filed Mar. 25, 2025. U.S. provisional application 63/777,539 and all other extrinsic references contained herein are incorporated by reference in their entirety.

### FIELD OF THE INVENTION

The field of the invention is locking mechanical fasteners.

### BACKGROUND

The background description includes information that may be useful in understanding the present invention. It is not an admission that any of the information provided herein is prior art or relevant to the presently claimed invention, or that any publication specifically or implicitly referenced is prior art.

A screw locking method utilizes Red (hereinafter Red) or Blue (hereinafter Blue) thread locking compound (e.g.-Loctite). Red is of the highest strength and often requires heating of the parts to allow disassembly while Blue can be loosened by hand tools. However, it is widely known that Blue does not provide enough holding/locking strength in many applications.

Thus, there is still a need for a High Strength Thread Locking System (hereinafter HSTLS) that can be disassembled with hand tools but is stronger than the holding/locking strength of the current Blue.

### SUMMARY OF THE INVENTION

The inventive subject matter provides apparatus, systems and methods in which the threads of a screw and its corresponding threads of a threaded hole comprise Disruptions. Disruptions alter the uniformity of threads and provide “keying” functions when thread locking compound hardens. That is, a Hole Thread Disruption (hereinafter HTD) keys/locks hardened thread locking compound to the hole and the hardened thread locking compound (in turn) keys/locks the screw via a Screw Thread Disruption (hereinafter STD).

Various objects, features, aspects and advantages of the inventive subject matter will become more apparent from the following detailed description of preferred embodiments, along with the accompanying drawing figures in which like numerals represent like components.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

The following description includes information that may be useful in understanding the present invention. It is not an admission that any of the information provided herein is prior art or relevant to the presently claimed invention, or that any publication specifically or implicitly referenced is prior art.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### BRIEF DESCRIPTION OF THE DRAWING

FIG. 1 is an isometric view of a Prior Art Screw (hereinafter PAS) 1 and its corresponding Prior Art Threaded Hole (hereinafter PATH) 2 in a disassembled state.

FIG. 2 is a top view of PATH 2 of FIG. 1.

FIG. 3 is a side view of an assembled PAS 1, PATH 2 and a Prior Art Hardened Thread Locking Compound (hereinafter PAHTLC) 3 (with PATH 2 and PAHTLC 3 cutaway for illustrative clarity).

FIG. 4 is is an isometric view of FIG. 3.

FIG. 5 is a cutaway isometric view of only the PAHTLC 3 of FIG. 4.

FIG. 6 is an isometric view of the components of a HSTLS in a disassembled state. HSTLC comprises a Disrupted Screw (hereinafter DS) 4 and a Disrupted Hole (hereinafter DH) 6.

FIG. 7 is a top view of DH 6 of FIG. 6.

FIG. 8 is an isometric view of DH 6 of FIG. 6 (cutaway for illustrative clarity).

FIG. 9 is a bottom view of DS 4 of FIG. 6.

FIG. 10 is a top-left isometric view of FIG. 9.

FIG. 11 is a bottom-right isometric view of FIG. 9.

FIG. 12 is a side view of an assembled DS 4, DH 6 and a Hardened Thread Locking Compound (hereinafter HTLC) 8 (with DH 6 and HTLC 8 cutaway for illustrative clarity).

FIG. 13 is an isometric view of FIG. 12.

FIG. 14 is a cutaway isometric view of only the HTLC 8 of FIG. 12.

FIG. 15 is a Sectional View A-A of FIG. 12.

FIG. 16 is a side view of an assembled DS 4, Alternate Embodiment DH (hereinafter AEDH) 11 and an Alternate Embodiment Hardened Thread Locking Compound (hereinafter AEHTLC) 13 (with AEDH 11 and AEHTLC 13 cutaway for illustrative clarity).

FIG. 17 is a detailed view of Section A of FIG. 16.

FIG. 18 is a cutaway isometric view of only the AEHTLC 13 of FIG. 16.

FIG. 19 is an isometric view of an assembled Other HSTLS comprising a Disrupted Nut 15 (cutaway for illustrative clarity).

FIG. 20 is an isometric view of an Alternate Embodiment DS 17.

FIG. 21 is a front (cutaway for illustrative clarity) view of a Multi Direction Thread Embodiment Hole 19.

FIG. 22 is an isometric view of FIG. 21.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

All figures show only approximate representations of the components of the systems and may not be accurate in size and/or positions.

A 6×32 inch Screw and its corresponding hole are illustrated in these figures.

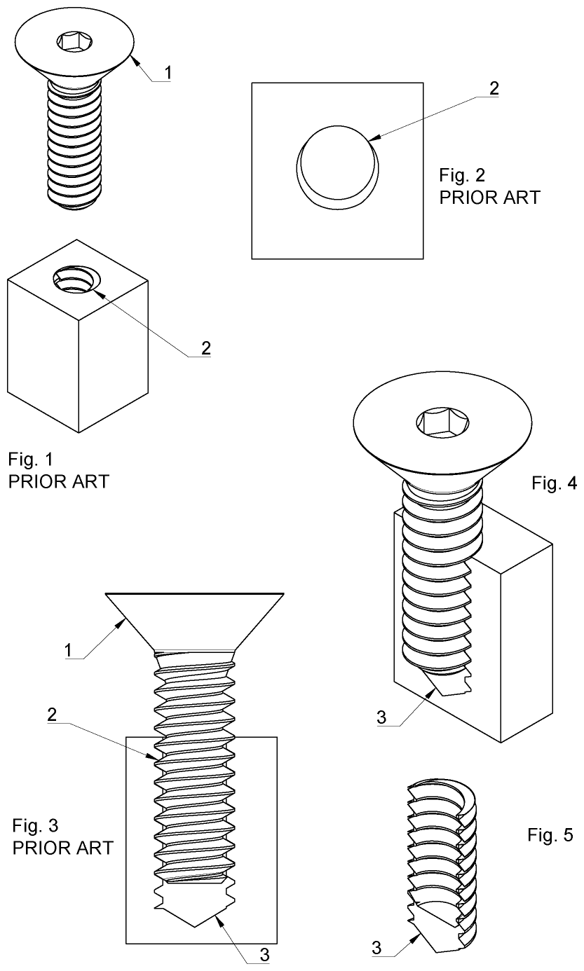

FIG. 1 is an isometric view of a PAS 1 and its corresponding PATH 2 in a disassembled state.

FIG. 2 is a top view of path 2 of FIG. 1.

FIG. 3 is a side view of an assembled PAS 1, PATH 2 and PAHTLC 3 (with PATH 2 and PAHTLC 3 cutaway for illustrative clarity).

FIG. 4 is is an isometric view of FIG. 3.

FIG. 5 is a cutaway isometric view of only the PAHTLC 3 of FIG. 4. Communication between the uniform threaded portions of PAHTLC 3 and the uniform threads of PAS 1 provides only a limited amount of holding/locking strength.

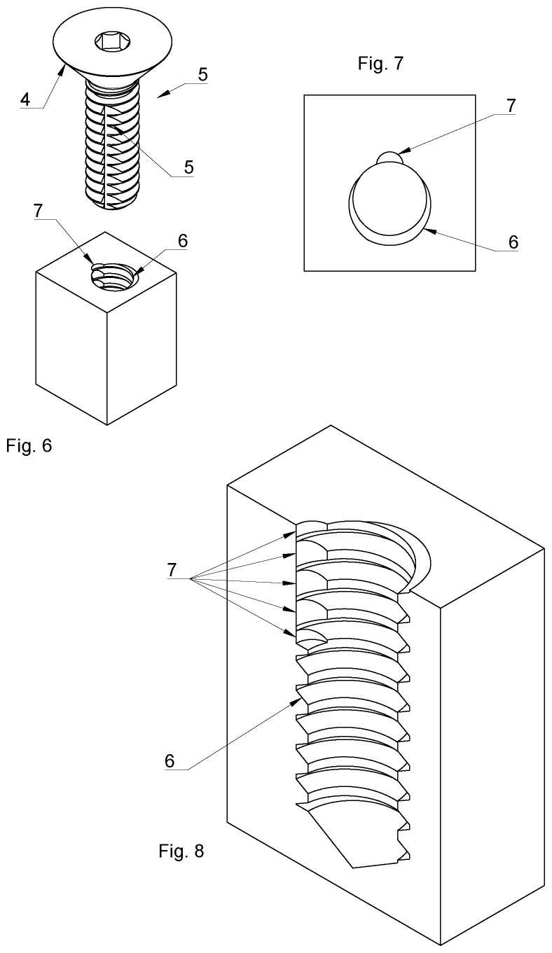

FIG. 6 is an isometric view of the components of a HSTLS in a disassembled state. HSTLC comprises a DS 4 and a DH 6.

FIG. 7 is a top view of DH 6 of FIG. 6. HTD 7 is realized by drilling a miniscule hole so that its cylinder is tangent to the “Major” (known term describing the largest) feature of a 6×32 inch internal thread.

FIG. 8 is an isometric view of DH 6 of FIG. 6 (cutaway for illustrative clarity). In this example, HTD 7 is incorporated into approximately 4 threads of DH 6.

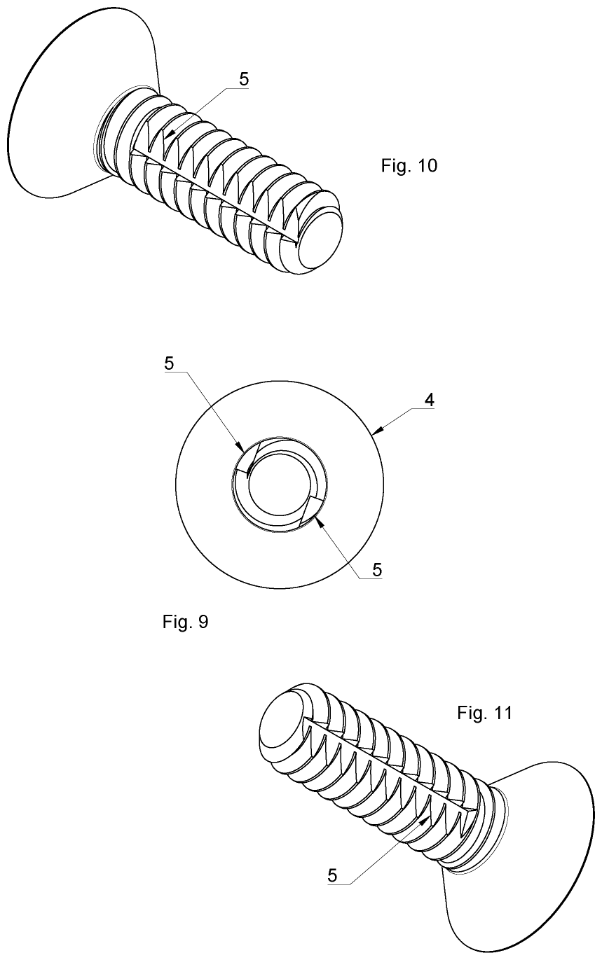

FIG. 9 is a bottom view of DS 4 of FIG. 6. DS 4 comprises at least one STD 5. STDs 5 in this example are two slots (configured 180 degrees apart) running along the majority of DS's 4 shaft.

FIG. 10 is a top-left isometric view of FIG. 9 illustrating a first STD 5.

FIG. 11 is a bottom-right isometric view of FIG. 9 illustrating the other STD 5.

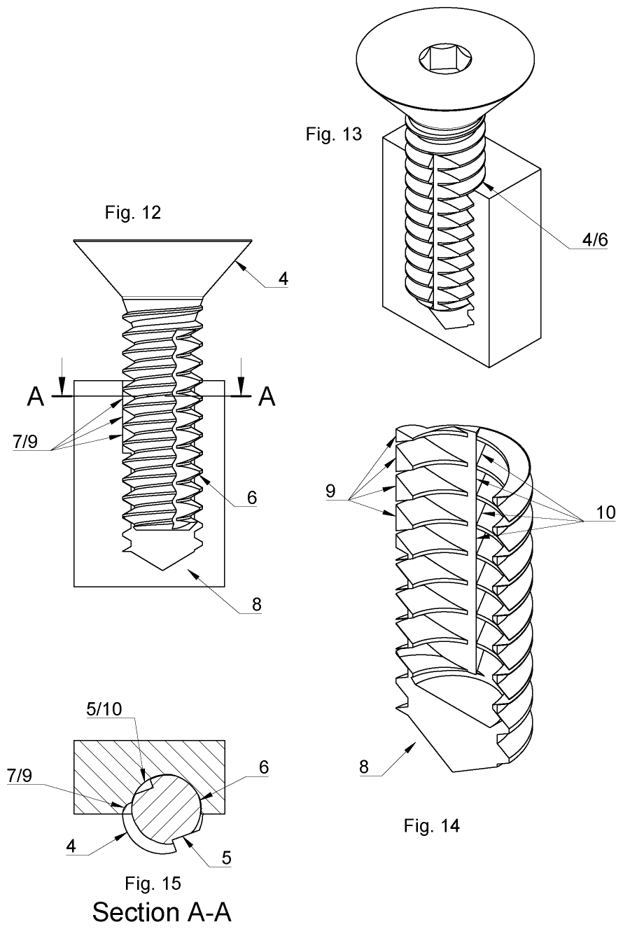

FIG. 12 is a side view of an assembled DS 4, DH 6 and a HTLC 8 (with DH 6 and HTLC 8 cutaway for illustrative clarity).

FIG. 13 is an isometric view of FIG. 12.

FIG. 14 is a cutaway isometric view of only the HTLC 8 of FIG. 12. HTLC 8 further comprises Hardened Thread Locker to Hole Disruption Key (hereinafter HTLTHDK) 9 and Hardened Thread Locker to Screw Disruption Key (hereinafter HTLTSDK) 10.

FIG. 15 is a Sectional View A-A of FIG. 12. HTLTHDK 9 Locks HTLC 8 to DH 6 and HTLC 8 (in turn) locks DS 4 via HTLTSDK 10. Communication between HTLC 8, DS 4 and DH 6 provide for stronger holding/locking strength than the prior art (i.e.-Blue).

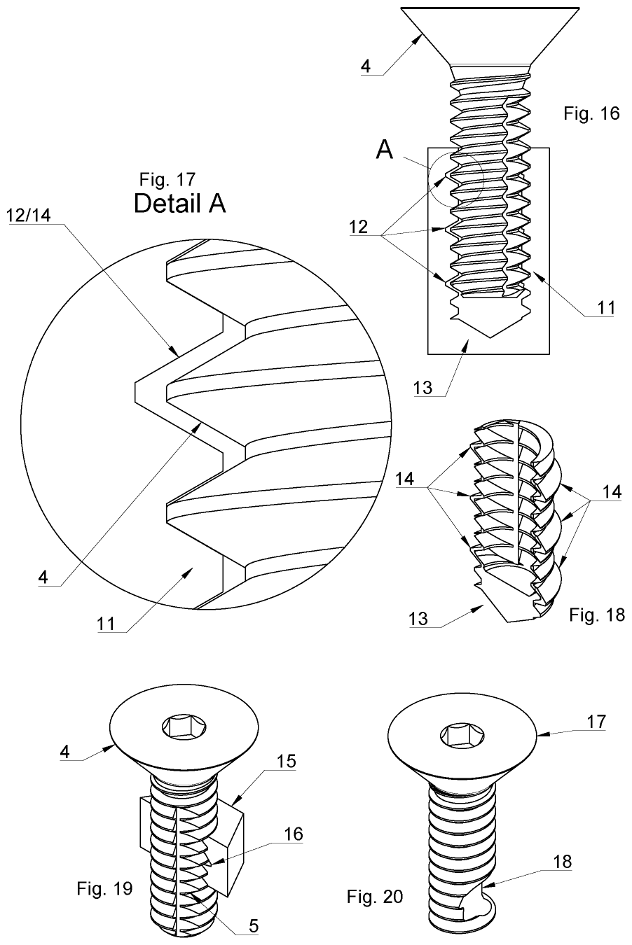

FIG. 16 is a side view of an assembled DS 4, Alternate Embodiment DH (hereinafter AEDH) 11 and an Alternate Embodiment Hardened Thread Locking Compound (hereinafter AEHTLC) 13 (with AEDH 11 and AEHTLC 13 cutaway for illustrative clarity).

FIG. 17 is a detailed view of Section A of FIG. 16. AEDH 11 comprises at least one Larger Than Major Diameter Threaded Portion (hereinafter LTMDTP) 12.

FIG. 18 is a cutaway isometric view of only the AEHTLC 13 of FIG. 16. LTMDTP 12 (FIG. 17) of AEDH 11 causes AEHTLC 13 to have at least one Larger Than Major Diameter Threaded Portion Key (hereinafter LTMDTPK) 14. LTMDTPK 14 locks AEHTLC 13 to AEDH 11 since LTMDTPK 14 could not be “squeezed” into the normally sized threads of AEDH 11. AEHTLC's 13 communication with STD 5 of DS 4 (FIG. 9) in turn locks DS 4.

FIG. 19 is an isometric view of an assembled Other HSTLS comprising a Disrupted Nut 15 (cutaway for illustrative clarity). Disrupted Nut 15 further comprises at least one Nut Disruption 16. Nut Disruption 16 functions similarly to LTMDTP 12 of AEDH 11 of FIG. 17.

FIG. 20 is an isometric view of an Alternate Embodiment DS 17. Alternate Embodiment DS 17 further comprises a Disruption Divot 18. Disruption Divot 18 functions similarly to STD 5 of DS 4 of FIG. 9.

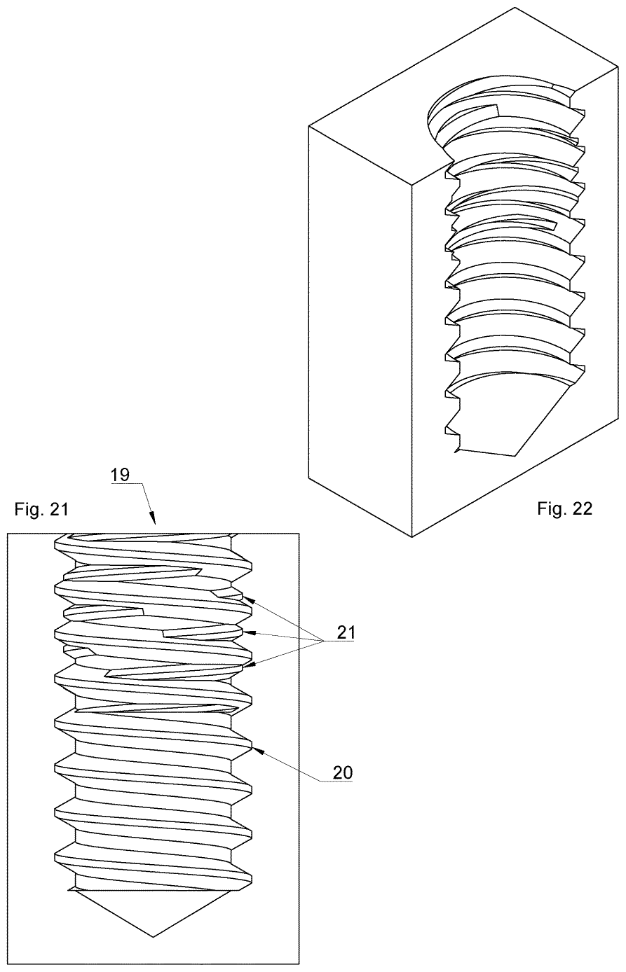

FIG. 21 is a front (cutaway for illustrative clarity) view of a Multi Direction Thread Embodiment Hole (hereinafter MDTEH) 19. In this example, MDTEH 19 comprises an Opposite/Left Hand ANSI #5 Thread (hereinafter OHA#5T) 21 and Right Hand ANSI #6 Thread 20. OHA #5T 21 functions the same as HTD 7 (FIG. 6) and LTMDTP 12 (FIG. 17).

FIG. 22 is an isometric view of FIG. 21.

The invention could be manufactured using any industry standard materials (metals, alloys, sheet metal, plastics, etc.) and processes (injection molding, MIM, sheet metal folding, additive manufacturing/3D printing, subtractive machining, etc.). Alternative embodiments, combinations, and/or uses of the methods and devices described above, and obvious modifications and equivalents thereof are intended to be included within the scope of the invention.

Although the described embodiments illustrate a 6×32 inch system, it is not meant to be limited to just that size (i.e.-the invention is applicable to other size screws/bolts/nuts).

It should be apparent to those skilled in the art that many more modifications, besides those already described, are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

What is claimed is:

1. A High Strength Thread Locking System comprising a Disrupted Screw, a Disrupted Hole, and Thread Locking Compound;
the Disrupted Screw having at least one Screw Thread Disruption,
the Disrupted Hole having at least one Hole Thread Disruption,
the Compound configured to fill the Disruptions during assembly of the Screw into the Hole and harden after assembly.

2. The system of claim 1 where the Disrupted Screw is configured as a Bolt.

3. The system of claim 1 where the Disrupted Hole is configured as a Nut.

4. The system of claim 1 where the Hole Thread Disruption is configured as an Opposite Direction Thread.
